(19) United States
(12) Patent Application Publication
(10) Pub. No.: US 2021/0240186 A1
(43) Pub. Date: Aug. 5, 2021

(54) INFORMATION PROCESSING APPARATUS, INFORMATION PROCESSING METHOD, AND NON-TRANSITORY MEMORY MEDIUM

(71) Applicant: TOYOTA JIDOSHA KABUSHIKI KAISHA, Toyota-shi (JP)

(72) Inventors: Tatsuya MATSUNAMI, Nisshin-shi (JP); Atsuko YAMANAKA, Toyota-shi (JP); Kunihiro TSUNEKAWA, Toyota-shi (JP); Sokfan YEE, Toyota-shi (JP); Masahiro TANAKA, Toyota-shi (JP); Shuichiro TAKAHASHI, Okazaki-shi (JP); Satoshi NONOYAMA, Toyota-shi (JP); Tokuyuki NISHIKAWA, Toyota-shi (JP); Hikaru SATOU, Okazaki-shi (JP)

(73) Assignee: TOYOTA JIDOSHA KABUSHIKI KAISHA, Toyota-shi (JP)

(21) Appl. No.: 17/163,647

(22) Filed: Feb. 1, 2021

(30) Foreign Application Priority Data
Jan. 30, 2020 (JP) 2020-013558

(51) Int. Cl. G05D 1/02; B60W 60/00; G06Q 10/08

(52) U.S. Cl. CPC G05D 1/0212; G06Q 10/08355; B60W 60/00253; B60W 60/00256

(57) ABSTRACT

An information processing apparatus includes a control unit that acquires, for a running unit from which an attachment unit is detachable, a time slot in which detachment of the attachment unit is permitted, and selects, from multiple services, a service to be provided by using the running unit from which the attachment unit is detached, according to the acquired time slot.

### CROSS REFERENCE TO RELATED APPLICATION

This application claims the benefit of Japanese Patent Application No. 2020-013558, filed on Jan. 30, 2020, which is hereby incorporated by reference herein in its entirety.

### BACKGROUND

### Technical Field

The present invention relates to an information processing apparatus, an information processing method, and a non-transitory memory medium storing a program therefor.

### Description of the Related Art

Patent document 1 proposes an autonomous vehicle including a running unit that does not have a vehicle interior unit but an attachable upper component, and a coupling unit that is detachably attached to the running unit. The coupling unit is configured to be coupled to the aforementioned upper component.

### CITATION LIST

### Patent Document

[Patent document 1] International Publication No. 2018/230720

### SUMMARY

An object of the present invention is to expand the range of application of a running unit from which an attachment unit can be detached.

One aspect of an embodiment of the present invention is exemplified by an information processing apparatus including a control unit. The control unit is configured to acquire, for a running unit from which an attachment unit is detachable, a time slot in which detachment of the attachment unit is permitted, and select a combination of a running unit from which the attachment unit is to be detached and a service that can be implemented using the running unit and uses the running unit in the time slot separately from the attachment unit, according to the acquired time slot. Another aspect of the embodiment of the present invention is exemplified by an information processing method in at least one computer such as an information processing apparatus including the control unit. Still another aspect of the embodiment of the present invention is exemplified by a non-transitory memory medium storing a program to be executed by the at least one computer.

The present invention can extend the range of application of the running unit from which an attachment unit is detachable.

### BRIEF DESCRIPTION OF THE DRAWINGS

FIG. 1 is a conceptual diagram of a system according to an embodiment;

FIG. 2 is a block diagram schematically illustrating the configuration of a running unit in the embodiment;

FIG. 3 is a block diagram schematically illustrating the configuration of a server device in the embodiment;

FIG. 4 is a block diagram schematically illustrating the configuration of a user device in the embodiment;

FIG. 5 is a flow chart of processing executed in the server device;

FIG. 6 is a flow chart of processing executed in the server device; and

FIG. 7A is a diagram illustrating an example of running unit information.

FIG. 7B is a diagram illustrating an example of service information.

### DESCRIPTION OF THE EMBODIMENTS

This embodiment illustrates an information processing apparatus including a control unit. The control unit of the information processing apparatus acquires a time slot in which for a running unit from which an attachment unit is detachable, the detachment of the attachment unit is permitted, and selects a service to be provided using the running unit from which the attachment unit is detached, among multiple services according to the acquired time slot. This embodiment also illustrates an information processing method for the information processing apparatus. Further, this embodiment illustrates a non-transitory memory medium that stores a program for executing the information processing method for the information processing apparatus.

An example of the attachment unit is a vehicle interior unit mounted on the running unit. A time slot in which detachment of the attachment unit is permitted can be called a time slot in which even if the attachment unit is detached from the running unit and the running unit is used by a third party, no harm is caused to the owner (including the main user) of the running unit and the attachment unit. Alternatively, the time slot can be called a time slot in which the owner does not use either the attachment unit or the running unit, and a time during which the detached attachment unit is used but the running unit is not used.

The control unit of the information processing apparatus acquires a time slot in which the detachment of the attachment unit is permitted for the running unit from which the attachment unit is detachable. This acquisition of the time slot may be executed by estimation based on the schedule information on the user using the attachment unit.

The control unit of the information processing apparatus may acquire at least one of the specifications and position of the running unit and the service permitted by the owner of the running unit, and select a service to be provided using the running unit based on the acquired information.

According to this embodiment, the range of application of the running unit can be extended.

<System Overview>

An information processing apparatus according to an embodiment of the present invention, an information processing method for the control unit of the information processing apparatus, and a non-transitory memory medium that stores a program will now be described with reference to the accompanying drawings.

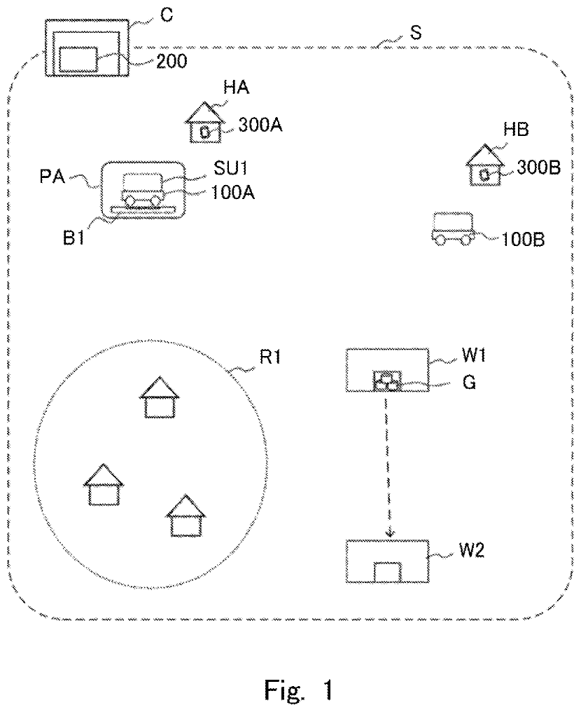

FIG. 1 conceptually illustrates a service providing system S according to the embodiment of the present invention. The service providing system S determines a service to be provided using a running unit 100 when an attachment unit SU can be detached from the running unit 100 for use.

Examples of the service provided by the running unit from which the attachment unit is detached include package delivery services (distribution services), human transporting services (people flow services), vehicle transporting or towing services, patrol services, and power supply services (charging services) for another running unit (second running unit) with a dead battery, and transportation services for another running unit with a dead battery. The service can be provided by coupling another attachment unit suitable for the service to the running unit from which the attachment unit is detached.

As illustrated in FIG. 1, a system S according to this embodiment includes running units 100 (100A, . . . ) and a server device 200. The system S also includes user devices 300 (300A, . . . ).

The running units 100 are moving objects that can run according to operation commands from the server device 200. The server device 200 is an information processing apparatus (computer) located in a data center C. The server device 200 is configured to be communicable with each running unit 100 via the network N, and cooperates with an information processing apparatus 102 of the running unit 100 via the network N. Note that FIG. 1, for example, illustrates only the running units 100A and 100B among the multiple running units 100 (100A, . . . ). The number of running units 100 however is not limited by this and may be one or more, or any number.

The server device 200 can communicate with other server devices and the like via the network N. The server device 200 is configured to be communicable with each running unit 100, and is also configured to be communicable with each user device 300 via the network N.

The user device 300 is configured to be communicable with the server device 200 via the network N. The user device 300 is also configured to be communicable with the running unit 100 via the network N. FIG. 1, for example, illustrates only the user devices 300A and 300B among the multiple user devices 300 (300A, . . . ). The number of user devices however is not limited by this and may be any number.

The running unit 100 is a type of autonomous vehicle here, and is also called electric vehicle (EV) pallet. The running unit 100 is configured to be a moving object capable of automatic driving and driverless driving. In the system S, the running units 100 have various sizes and configurations. The running unit 100 may be configured so that a person can get on and off the vehicle. The running unit 100 does not necessarily have to be a vehicle capable of autonomous running. For instance, the running unit 100 may be a vehicle driven or assisted manually depending on the situation. An attachment unit SU can be connected to a running unit 100. An attachment unit SU is, for example, a vehicle interior unit or a store unit. Different attachment units SU can be connected to one running unit 100, and different attachment units SU can be connected to the running unit 100 and used depending on the application.

As described above, each running unit 100 is configured to be communicable with user devices 300 via the network N. Each user device 300 can receive an input and the related operation from the user, and can communicate not only with the server device 200 but also with running units 100 via the network N.

The server device 200 is, for example, a device that commands the running units 100 to operate. For instance, the server device 200 provides, that is, transmits an operation command including a travel plan for a running unit 100 to the running unit 100.

Each component of the system S illustrated in FIG. 1 will be described in detail below. The running unit 100 will be described first.

The running units 100 are capable of running alone, and are configured so that the attachment units SU (SU1, . . . ) are detachable from, that is, attachable to them. In FIG. 1, each attachment unit SU1 is placed on and attached to the top of the corresponding running unit 100A. Note that the attachment unit SU is not necessarily placed on and attached to the running unit 100, and may be a unit configured to be towed by the running unit 100, for example.

<Running Unit>

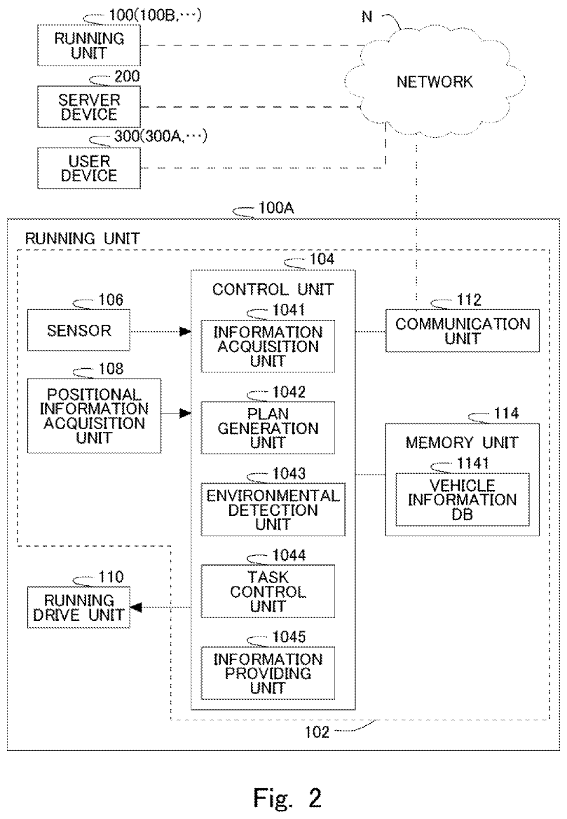

FIG. 2 is a block diagram illustrating the configuration of a running unit 100. FIG. 2 illustrates the configuration of the running unit 100A as an example of running unit 100. Other running units 100 (100B, . . . ) have the same configuration as the configuration described below.

The running unit 100A includes an information processing apparatus 102 and a control unit 104 that substantially functions as the information processing apparatus 102. The running unit 100A can, for example, run according to the operation command from the server device 200. To be specific, the running unit 100A runs by an appropriate method while sensing the surroundings of the vehicle based on the operation command acquired via the network N. While running in this manner, the running unit 100A can provide various users with services.

The running unit 100A further includes a sensor 106, a positional information acquisition unit 108, a running drive unit 110, a communication unit 112, and a memory unit 114. The running unit 100A operates with the electric power supplied from the battery.

The sensor 106 is a unit for sensing the surroundings of the vehicle, and typically includes a stereo camera, a laser scanner, a light detection and ranging or laser imaging detection and ranging (LIDAR), and radar. The information acquired by the sensor 106 is transmitted to the control unit 104. The sensor 106 includes a sensor for the vehicle to run autonomously. The sensor 106 includes a camera provided on the vehicle body of the running unit 100A. Examples of the camera include charged-coupled devices (CCD) and photographing devices using metal-oxide-semiconductor (MOS) or complementary metal-oxide-semiconductor (CMOS) image sensors.

The positional information acquisition unit 108 is a unit for acquiring the current position of the running unit 100A. The positional information acquisition unit 108 includes a global positioning system (GPS) receiver. The GPS receiver as a satellite signal receiver receives signals from multiple GPS satellites. Each GPS satellite is an artificial satellite that orbits the earth. The satellite positioning system, that is, the navigation satellite system (NSS) is not limited to GPS. Positional information may be detected based on signals from various satellite positioning systems. The NSS is not limited to the global navigation satellite system, and may be a quasi-zenith satellite system, for example, “Galileo” from Europe or “Michibiki” from Japan that operates in an integrated manner with the GPS. The positional information acquisition unit 108 may include a receiver that receives radio waves from a transmitter such as a beacon. In this case, multiple transmitters should be placed at stores or the sides of roads, for example, and regularly emit radio waves of a specific frequency or signal format. The positional information detection system including the positional information acquisition unit 108 is not limited to these technologies.

The control unit 104 is a computer that controls the running unit 100A according to the information from, for example, the sensor 106 and the positional information acquisition unit 108. The control unit 104 is an example of a controller that controls the movement of the running unit 100A, the transportation of various products, and the like.

The control unit 104 includes a CPU and a main memory unit, and executes a program to perform information processing. The CPU is also called processor. The main memory unit of the control unit 104 is an example of main memory. The CPU in the control unit 104 executes a computer program expanded in the main memory unit in an executable manner, thereby providing various functions. The main memory unit in the control unit 104 stores computer programs and/or data to be executed by the CPU. The main memory unit in the control unit 104 is, for example, a dynamic random access memory (DRAM), a static random access memory (SRAM), or a read only memory (ROM).

The control unit 104 is connected to the memory unit 114. The memory unit 114, which is a so-called external memory unit, is used as a memory area that is an auxiliary memory for the main memory unit of the control unit 104 and stores a computer program and/or data to be executed by the CPU of the control unit 104. The memory unit 114 is, for example, a hard disk drive or a solid state drive (SSD).

The control unit 104 has, as functional modules, an information acquisition unit 1041, a plan generation unit 1042, an environmental detection unit 1043, a task control unit 1044, and an information providing unit 1045. Each functional module is implemented by executing a program stored in the main memory unit and/or the memory unit 114 by the control unit 104, that is, the CPU in it.

The information acquisition unit 1041 acquires information such as an operation command, including a travel plan, from the server device 200. The operation command may include information on the service provided by the running unit 100A. The information acquisition unit 1041 regularly or irregularly acquires the information on the vehicle and stores it in a vehicle information database 1141 of the memory unit 114. The information acquisition unit 1041 also acquires information from the user device 300. When the user device 300 of a user A who uses the running unit 100A is the user device 300A, the information acquisition unit 1041 can acquire the user ID and the like unique to the user device 300A from the user device 300A. Additionally, when the user device 300 of the user A who uses the running unit 100A is the user device 300A, the information acquisition unit 1041 can acquire various positional information from the user device 300A, for example, the positional information on the user device 300A.

The plan generation unit 1042 generates an operation plan for the vehicle based on the operation command acquired from the server device 200, particularly based on the information on the travel plan included therein. Note that the operation plan generated by the plan generation unit 1042 is transmitted to the task control unit 1044 described later. In this embodiment, an operation plan is data that defines the route of the autonomous vehicle 100A and the processing supposed to be performed by the autonomous vehicle 100A on part or all of the route. Examples of data included in the operation plan are as follows.

(1) Data Representing the Route of the Vehicle by a Set of Road Links

The route of the vehicle may be automatically generated based on a given departure point and destination while referring to the map data stored in the memory unit 114 and the information on the travel plan included in the operation command. The route may be generated using an external service.

(2) Data Representing the Processing Supposed to be Performed by the Vehicle at a Point on the Route

Examples of processing supposed to be performed by the vehicle on the route include, but are not limited to, “product transportation”.

The environmental detection unit 1043 detects the environment around the vehicle based on the data acquired by the sensor 106. Examples of detection targets include, but are not limited to, the number and positions of lanes, the number and positions of vehicles existing around the vehicle, and the number and positions of obstacles (for example, pedestrians, bicycles, structures, and buildings) existing around the vehicle, road structures, and road signs. Any target may be detected as long as it is necessary for autonomous running. The environmental detection unit 1043 may track the detected object. For instance, the relative speed of the object may be calculated from the difference between the coordinates of the object detected one step before and the current coordinates of the object. The environment-related data (hereinafter, environment data) detected by the environmental detection unit 1043 is transmitted to the task control unit 1044 described later.

The task control unit 1044 controls the operation, that is, running of the running drive unit 110 of the vehicle based on the operation plan generated by the plan generation unit 1042, the environment data generated by the environmental detection unit 1043, and the positional information on the vehicle acquired by the positional information acquisition unit 108. For example, the task control unit 1044 runs the vehicle along a predetermined route and runs the vehicle such that an obstacle does not come in a predetermined safety area around the vehicle. A known method can be adopted as a method for causing the vehicle to run autonomously. The task control unit 1044 also executes tasks other than running based on the operation plan generated by the plan generation unit 1042. An example task is to attach/detach an attachment unit SU.

The information providing unit 1045 provides the server device 200 with information on the vehicle. This provision may be performed regularly or irregularly.

The running drive unit 110 is a unit for running the running unit 100A according to commands generated by the task control unit 1044. The running drive unit 110 includes, for example, a motor for driving wheels, an inverter, a brake, a steering mechanism, and a secondary battery.

The communication unit 112 has communication means for connecting the running unit 100A to the network N. In this embodiment, the running unit 100A can communicate with other devices such as the server device 200 and the user device 300A via the network N. Note that the communication unit 112 may further include communication means for the vehicle, that is, the running unit 100A to perform inter-vehicle communication with other running units 100 (100B, . . . ).

<Server Device>

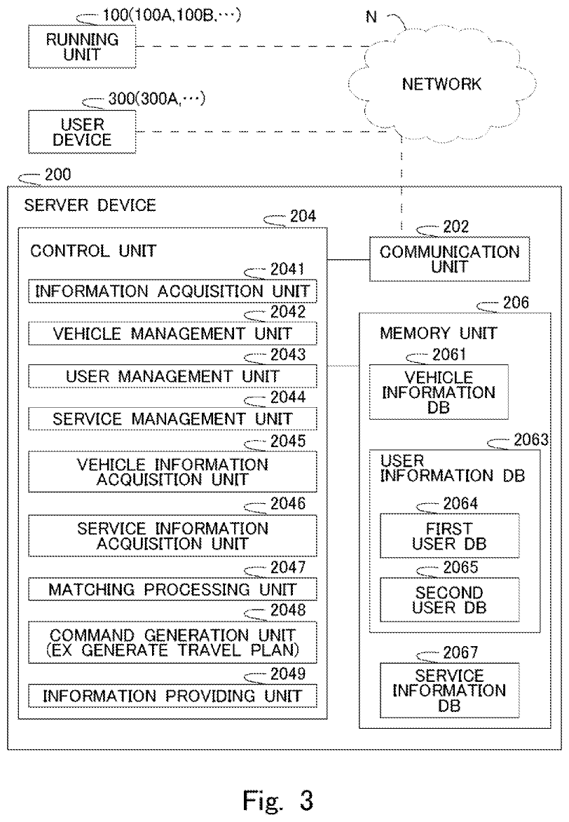

FIG. 3 is a block diagram illustrating the configuration of the server device 200. The server device 200 provides information on various operation commands, such as information on services for the respective running units 100.

The server device 200 is an information processing apparatus consisting of a communication unit 202, a control unit 204, and a memory unit 206. The communication unit 202, which is similar to the communication unit 112, has a communication function for connecting the server device 200 to the network N. The communication unit 202 of the server device 200 is a communication interface for communicating with the running unit 100 and the user device 300 via the network N. Like the control unit 104, the control unit 204 includes a CPU and a main memory unit, and executes a program to perform information processing. This CPU is, of course, also a processor, and the main memory unit of the control unit 204 is also an example of main memory. The CPU in the control unit 204 executes a computer program expanded in the main memory unit in an executable manner, thereby providing various functions. The main memory unit in the control unit 204 stores computer programs and/or data to be executed by the CPU. The main memory unit in the control unit 204 is a DRAM, SRAM, ROM or the like.

The control unit 204 is connected to the memory unit 206. The memory unit 206, which is an external memory unit, is used as a memory area that is an auxiliary memory for the main memory unit of the control unit 204 and stores a computer program and/or data to be executed by the CPU of the control unit 204. The memory unit 206 is a hard disk drive, SSD, or the like.

The control unit 204 is a unit for controlling the server device 200. As illustrated in FIG. 3, the control unit 204 includes, as functional modules, an information acquisition unit 2041, a vehicle management unit 2042, a user management unit 2043, a service management unit 2044, a vehicle information acquisition unit 2045, a service information acquisition unit 2046, a matching processing unit 2047, a command generation unit 2048, and an information providing unit 2049. Each functional module is implemented by executing a program stored in the main memory unit and/or the memory unit 206 by the CPU of the control unit 204.

The information acquisition unit 2041 acquires various types of information from the running unit 100 and the user device 300. The acquired information is transmitted to the vehicle management unit 2042, the user management unit 2043, and the like. The information acquisition unit 2041 regularly acquires, for example, the positional information and the information in the vehicle information database 1141 from the running unit 100, and transmits it to the vehicle management unit 2042. Further, the information acquisition unit 2041 acquires the information on the registered user or the information input by the user from the user device 300 and transmits it to the user management unit 2043. In addition, the information acquisition unit 2041 acquires information on a demanded service to be provided by a service provider or service providing service, from the user device 300 or other devices, and transmits it to the service management unit 2044.

The vehicle management unit 2042 manages information on the multiple running units 100 which are under control. To be specific, the vehicle management unit 2042 receives information such as data on the running unit 100 from multiple running units 100 via the information acquisition unit 2041, and stores it in a vehicle information database 2061 of the memory unit 206. Positional information and vehicle information are used as information on the running unit 100. The vehicle information is, for example, an identifier, use application/type, information on a standby point, a vehicle body size, a load amount, a travelable distance when fully charged, a travelable distance at the present time, and a current status of the running unit 100. The use application/type, vehicle body size, and the like are stored in the vehicle information database 2061 as information on the specifications of the running unit 100. Further, here, the travelable distance at the present time is the remaining battery level at the present time.

Further, the vehicle management unit 2042 manages information on multiple attachment units SU (SU1, . . . ) which are under control. To be specific, the vehicle management unit 2042 stores information on, for example, the positional information on the attachment unit SU, the usage status or booking status, and the corresponding service acquired via the information acquisition unit 2041, together with the information on the running unit 100, in the vehicle information database 2061. Here, the aforementioned information on the attachment unit SU, which is acquired by input by an operator, communication with the running unit 100, or the like, may be acquired by providing the attachment unit SU with an information processing apparatus to which various sensors are connected so that it may be acquired by communication with this information processing apparatus.

The user management unit 2043 stores the registered user information in a user information database 2063 of the memory unit 206. Here, types of registered users include two types of users. One type of users (first users) are the owners or occupants of a running unit 100 and have the authority to preferentially use a specific running unit 100. The other type of users (second users) are users (end users) who are provided with the service using a running unit 100. Information from the first users is stored in a first user database 2064 of the user information database 2063. Information from the second users is stored in a second user database 2065 of the user information database 2063. The first user database 2064 may be completely separated from the second user database 2065. At least one of the first user database 2064 and the second user database 2065 may be provided separately from the user information database 2063.

For instance, when a first user inputs information on the usage schedule of the running unit 100 through the user device 300, the information is acquired via the information acquisition unit 2041 and stored in the first user database 2064 by the user management unit 2043. Note that the information on the first user is preferably acquired or stored so that a time slot in which detachment of the attachment unit SU is permitted can be extracted from the running unit 100, based on the information on the first user, for example, the schedule information. For instance, when the second user demands to use a service that can be provided by using one of the running units 100, the demanded information input from the user device 300 of the second user is similarly stored in the second user database 2065.

The service management unit 2044 stores information on a demanded service to be provided by a service provider or service providing service, in a service information database 2067 of the memory unit 206. The service information database 2067 stores information on services that can be implemented using the running unit 100. The service information database 2067 stores, in addition to the type of service, requirements for the running unit 100 to be used. The requirements are, for example, specifications (required specifications) required for the running unit 100 to be used. The information stored in the service information database 2067 is acquired via the information acquisition unit 2041, but is not necessarily provided by a service provider or service providing service. Information collected by the service management unit 2044 via the network N according to a predetermined program may be recorded in the service information database 2067.

The vehicle information acquisition unit 2045 acquires information on the running unit 100 from which the attachment unit SU is detachable, based on the information acquired from the first user database 2064. Below are examples of information on the running unit 100.
Time slot when detachment of the attachment unit SU is permitted (hereinafter referred to as available time slot)
Functions (specifications) of the running unit
Positional information
Remaining battery level or travelable distance
Information indicating for which service the owner of the running unit permits to use the running unit (hereinafter referred to as permission information)

The vehicle information acquisition unit 2045 acquires at least one of these pieces of information. The details of the information acquisition method will be described below with reference to a flowchart.

The service information acquisition unit 2046 acquires, from the service information database 2067, information on services that can be provided using the running unit 100. Below are examples of information on the services.
Type of Service
Service identification information (service ID)
Functions required for the running unit (required specifications)
Service-provided time slot
Service usage position
Minimum remaining battery level

The service information acquisition unit 2046 acquires at least one of these pieces of information. The details of the information acquisition method will be explained below with reference to a flowchart.

The matching processing unit 2047 performs a process of matching between multiple running units and multiple services by referring to the available time slots, and selects a service to be provided by using at least one running unit of the multiple running units 100. The matching process does not necessarily need to target multiple running units, and may be a process of selecting, for a specific running unit, a service to be provided by using the running unit from multiple services. The matching process is exerted depending on whether the running unit 100 having the available time slot acquired by the vehicle information acquisition unit 2045 and the service acquired by the service information acquisition unit 2046 have a relationship satisfying a predetermined condition. Simply stated, the predetermined condition is that the service can be implemented by using the running unit 100 during the available time slot of the running unit 100. The details of the matching process will be described below with reference to a flowchart.

The command generation unit 2048 generates an operation command including a travel plan of the running unit 100 so that the service selected by the matching processing unit 2047 is provided. For instance, when a service used in the available time slot of the running unit 100A is selected, an operation command including the travel plan of the running unit 100A related to the service and also, in some cases, a plan for attachment of the attachment unit SU to the running unit 100A is generated. The operation command may include, besides the type of service, positional information on the destinations, estimated arrival time at each destination, and the departure time (time when it departs) from each destination.

The information providing unit 2049 provides each running unit 100 with information on various operation commands generated by the command generation unit 2048 according to a predetermined program.

<User Device>

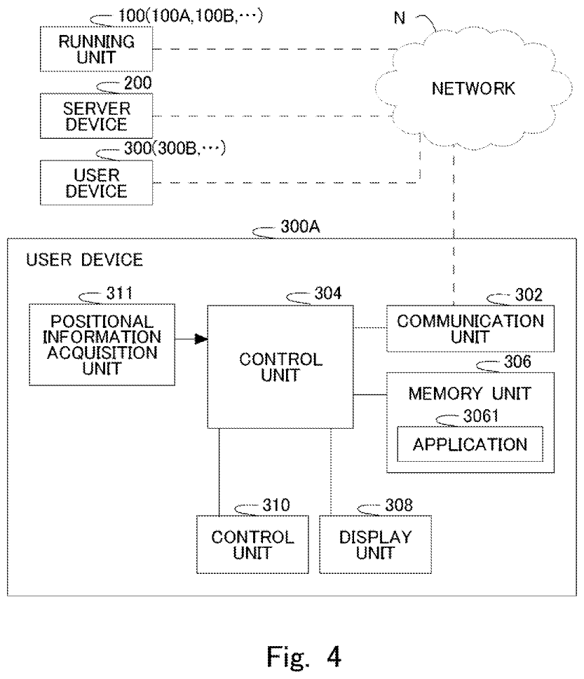

FIG. 4 is a block diagram illustrating the configuration of a user device 300. FIG. 4 illustrates the configuration of the user device 300A as an example of the user device. Other user devices 300 (300B, . . . ) have the same configuration as the configuration described below.

The user device 300A is, for example, a mobile terminal, a smartphone, or a personal computer. The user device 300A includes a communication unit 302, a control unit 304, and a memory unit 306. The communication unit 302 and the memory unit 306 of the user device 300A are the same as the communication unit 202 and the memory unit 206 of the server device 200, respectively. The user device 300A has a display unit 308 and an operation unit 310. The display unit 308 is, for example, a liquid crystal display or an electroluminescent panel. The operation unit 310 may be, for example, a keyboard or a pointing device. To be specific, the operation unit 310 in this embodiment has a touch panel and is substantially integrated with the display unit 308.

Like the control unit 204 of the server device 200, the control unit 304 has a CPU and a main memory unit. The CPU of the control unit 304 executes an application program (hereinafter referred to as application) 3061 stored in the memory unit 306. The application 3061 is an application program for accessing information from a web browser or the server device 200 or the running unit 100. The application 3061 has a GUI, receives an input, for example, an access from the user, and transmits it to the running unit 100 or the server device 200 via the network N. The user can input information indicating that the user wants to use the system S, through the user device 300. Here, this input is transmitted to the server device 200 or is made transmittable to the running unit 100 in some cases.

While the application 3061 is activated, the user A of the user device 300A can input, for example, a desired service and a desired date and time or a time slot for providing the service, from the display unit 308. At this time, the positional information from the positional information acquisition unit 311 can also be transmitted together with these pieces of information.

Note that, in FIGS. 2, 3, and 4, the running unit 100, the server device 200, and the user device 300 are connected via the same network N. However, these connections may be achieved via multiple networks. For instance, the network connecting the running unit 100 and the server device 200 and the network connecting the server device 200 and the user device 300 may be different networks.

<Matching Process>

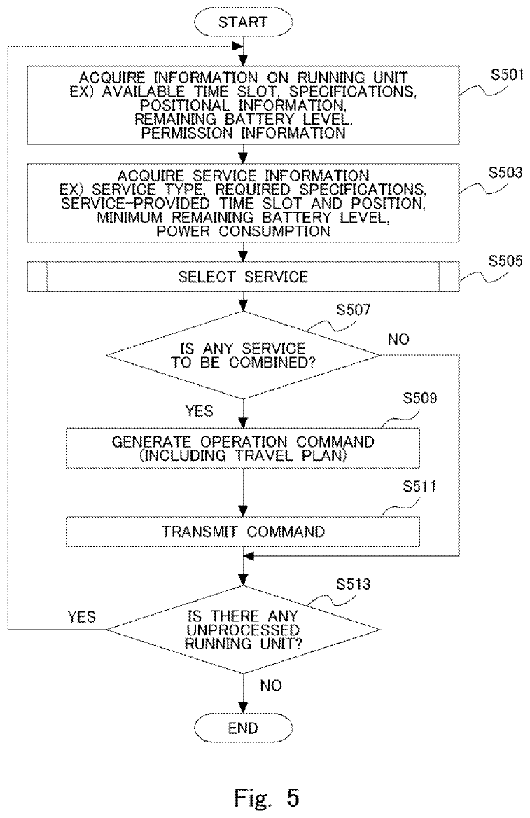

A matching process of determining a combination of a running unit 100 and a provided service in the system S will be described with reference to FIGS. 5 to 7. Here, the matching process refers to a process of determining at least one combination of a running unit and a provided service selected among multiple running units 100 and multiple provided services. FIG. 5 is a flowchart illustrating the flow of a process executed by the control unit 204 of the server device 200. The following description will be made assuming that an operation command for the running unit 100A to which the attachment unit SU1 is to be attached is generated according to the schedule of the user A who is the first user.

[S501: Acquisition of Running Unit Information]

In Step S501, the vehicle information acquisition unit 2045 of the control unit 204 acquires information on the running unit 100.

As described above, the information on the running unit 100 includes available time slots, specifications, positional information, a remaining battery level or travelable distance, and permission information. Methods of acquiring these pieces of information will be explained below.

The time slot (hereinafter referred to as available time slot) in which the attachment unit SU is permitted to be detached from the running unit 100 is acquired, for example, according to the schedule information on the owner of the running unit 100. The vehicle information acquisition unit 2045 can access the schedule server and acquire the owner's schedule information. When the available time slot is explicitly stored in the schedule server, the vehicle information acquisition unit 2045 may acquire the available time slot. The vehicle information acquisition unit 2045 may estimate the available time slot from the schedule information stored in the schedule server. For instance, with registered information on a schedule that can be estimated not to use the running unit (including the vehicle), the vehicle information acquisition unit 2045 can estimate that the time slot is an available time slot. The estimation of whether or not the registered schedule uses the running unit can be made according to the past action history, that is, whether the running unit has been used in the same or similar schedule. With registered information on a schedule that uses only the attachment unit SU, the vehicle information acquisition unit 2045 can determine that the time slot is an available time slot. When the travel plan of the running unit 100 is determined by the server device 200 or other devices, the available time slot of the running unit 100 may be acquired based on a travel plan acquired from the server device 200 or other devices.

Even if the running unit 100 is available on the schedule, the continuously available time may be limited depending on the remaining battery level. It is therefore preferable that the vehicle information acquisition unit 2045 estimates the available time slot of the running unit also based on the remaining battery level. For instance, even if it is found from the schedule that the running unit 100 is available between 9:00 and 16:00, the available time slot of the running unit 100 is estimated to be four hours between 9:00 and 16:00 when there is not enough battery power to run for four consecutive hours.

The function (specifications) of the running unit 100, the positional information, the remaining battery level, the travelable distance, and the permission information may be acquired from the first user database 2064. The specifications are prestored in the first user database 2064. The positional information, the remaining battery level, and the travelable distance are regularly transmitted from the running unit 100 to the first user database 2064. The positional information may be estimated based on schedule information or a travel plan. The permission information, that is, the information on the service permitted to be used by the owner of the running unit 100 is registered in the first user database 2064 from the user device 300. The permission information may be information indicating which service is permitted (white list) or information indicating which service is prohibited (black list).

Suppose, for example, that a plan, as the schedule of the user A, for not using the vehicle is registered in the period from 9:00 to 16:00 in the first user database 2064. During this period, the user A does not use the running unit 100A or the attachment unit SU1 and the running unit 100A is parked in a parking lot PA. It is also assumed that the user A permits the detachment between the running unit 100A and the attachment unit SU1 and the use of the running unit 100A. Accordingly, this time slot corresponds to the time slot in which the detachment of the attachment unit SU1 is permitted for the running unit 100A. At this time, this time slot is acquired as an available time slot. As described above, at this time, the vehicle information acquisition unit 2045 also acquires specifications of the running unit 100A, its positional information in the available time slot, and the remaining battery level in the available time slot.

For another example of available time slot, it is possible that a schedule in which the user A detaches the attachment unit SU from the running unit 100A and uses only the attachment unit is registered in the first user database 2064. For instance, it is assumed that the attachment unit is a camping vehicle interior unit, and the vehicle interior unit is detached from the running unit in a specific position in a time slot in order to use only the vehicle interior unit. It is also assumed that the attachment unit is a store unit, and the store unit is detached from the running unit in a specific position in a time slot in order to use only the store unit. In all of these examples in which the running unit 100A is available, a time slot in which the attachment unit and the running unit are separated corresponds to an available time slot.

[S503: Acquisition of Service Information]

In Step S503, the service information acquisition unit 2046 acquires information on one or more services stored in the service information database 2067.

As described above, examples of the service information include service types, service identification information (service ID), functions required for the running unit (required specs), service providing time slots, service use positions, and minimum remaining battery levels.

These pieces of information are prestored in the service information database 2067 by a service provider which provides a service through the running unit 100.

Examples of service types include package delivery services, human transporting services, vehicle towing services, charging services for another running unit (second running unit) with a dead battery, transportation services for another running unit with a dead battery, and patrol services.

The specifications required for the service are determined as appropriate according to the service type. For instance, in a package delivery or human transporting service, a running unit 100 is required to carry packages or people. A towing service is required to be capable of towing vehicles, a charging service is required to have charging equipment, and a patrol service is required to have a camera and an alarm device. The service-provided time slot and the service-provided position may be determined by the service provider or may be determined according to a request from the end user.

Note that a degree of priority may be included in the service information. The degree of priority may be defined by the service provider. Alternatively, the control unit of the server device 200 may assign a predetermined degree of priority according to the service type.

It is assumed here that three services: a patrol service, a package delivery service, and a charging service, have been acquired. The patrol service is a service that monitors abnormality using a surveillance camera and gives a warning when an abnormality is detected in the region R1 illustrated in FIG. 1. The patrol service is therefore required to have the functions of a surveillance camera and a warning device. Here, the package delivery service is a service for moving a package G in a warehouse W1 to a warehouse W2. The package delivery service requires the running units 100 to be loaded with packages. The charging service is a service for charging the second running unit 100B different from the running unit 100A. The charging service is registered according to a request from the user B, and is registered together with information on, for example, the position of the electric vehicle 100B and the required charging amount. For each of these services, the area where the service is provided and the service-provided time slot are also registered.

[S505: Combination Selecting Process]

In Step S505, the matching processing unit 2047 selects a combination of the running unit 100A and a suggested service. The matching processing unit 2047 checks the information on the running unit acquired in Step S501 against the information on the service acquired in Step S503, and selects the service to be provided by using the running unit 100.

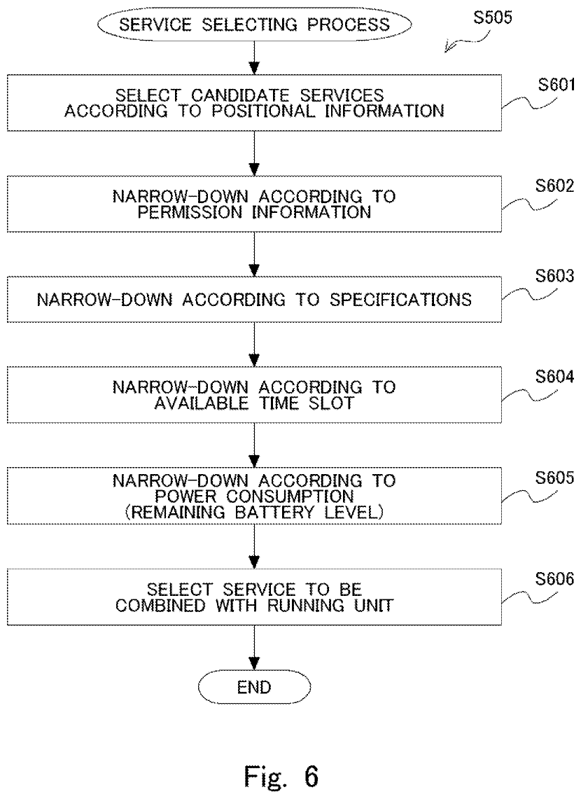

FIG. 6 is a flowchart illustrating the details of the matching process S505.

In Step S601, the matching processing unit 2047 compares the service-provided position, with the positional information on the running unit 100A, and narrows down the candidate services to be combined with the running unit 100A based on the comparison result. For example, the matching processing unit 2047 calculates the distance between the positional information on the running unit 100A and the service-provided position, and selects, as a candidate, a service whose calculated distance is less than or equal to a threshold.

In Step S602, the matching processing unit 2047 narrows down the candidate services to be combined with the running unit 100A based on the permission information indicating a service for which the running unit 100A is permitted by the user A. As described above, the user A has previously registered for which service the running unit 100A may be used or should not be used. As such, the matching processing unit 2047 selects a service that is not permitted or prohibited by the user A according to the permission information.

In Step S603, the matching processing unit 2047 narrows down services according to the comparison between the required service specifications and the running unit 100A specifications. If the running unit 100A has all the specifications required for a service, the matching processing unit 2047 selects the service as a candidate; otherwise the service is removed from the candidate list.

In Step S604, the matching processing unit 2047 narrows down services according to the comparison between the time slot when the service should be provided and the available time slot of the running unit 100A. To be specific, the time slot in which the service should be provided needs to be included in the available time slot of the running unit 100A. In this case, the period of time required to move the running unit 100A from the current position to the service-provided position and the period of time required to move it from the service-provided position to the current position (or the return position) of the running unit 100A should be considered. For instance, if the time slot when the service should be provided is from 12:00 to 16:00 and it takes 30 minutes to move from the current position of the running unit 100A to the service-provided position, the time slot when the service should be provided is regarded as substantially from 11:30 to 16:30. If the available time slot of the running unit 100A includes that time slot, this service becomes a candidate for a service to be combined with the running unit 100A.

In Step S605, the matching processing unit 2047 narrows down services according to the comparison between the amount of power (battery level) consumed in providing the service and the remaining battery level of the running unit 100A. For each of the candidate services, the matching processing unit 2047 estimates the amount of power consumed by the running unit 100A in providing the service, for example, based on the travel distance while the service is provided. This travel distance also includes the distance traveled between the current position of the running unit 100A and the service provided area. In a service such as a charging service that requires power supply, this amount of power is also added to the amount of power consumed in the service. If the remaining battery level of the running unit 100 is higher than the estimated power consumption of the service, the matching processing unit 2047 selects the service as a candidate; otherwise, the service is removed from the candidate list.

In Step S606, the matching processing unit 2047 determines any one of the services selected as candidates after the processing in Step S605 to be a service to be combined with the running unit 100A. When there are multiple candidates, which service should be combined may be determined as appropriate. For instance, the matching processing unit 2047 may randomly determine from multiple candidates, or preferentially determine a service that cannot be or is difficult to be combined with other running units, to be a service to be assigned to the running unit 100A.

The order of the narrowing-down processing in Steps S601 to S606 described above is not limited to a particular one, and may be changed. Some steps of the aforementioned narrowing-down processing may be omitted, or another step of narrowing-down processing may be added according to another criterion.

The matching process will be further explained taking a concrete example. Suppose that the following three services: a patrol service in the region R1, a package G transporting service from the warehouse W1 to the warehouse W2, and a user B's electric vehicle 100B charging service illustrated in FIG. 1 are selected as candidate services provided near the current position of the running unit 100A in Step S601.

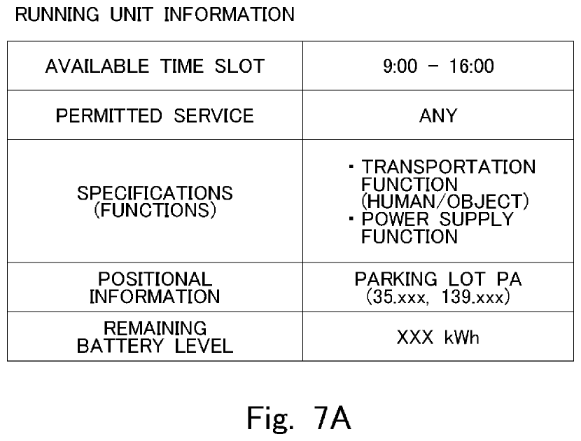

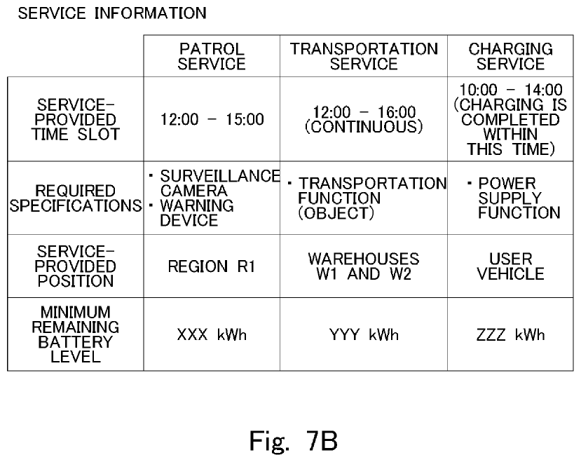

It is also assumed that the information illustrated in FIG. 7A has been acquired as vehicle information on the running unit 100A. It is also assumed that the information illustrated in FIG. 7B has been acquired as information on the aforementioned three services.

In the narrowing-down step based on the permission information (S602), the running unit 100A is permitted to be used for any service, so that the aforementioned three services remain as candidates. In the narrowing-down step based on the specifications (S603), the patrol service requires the ownership of a surveillance camera and a warning device, but since the running unit 100A does not have these functions, the patrol service is removed from the candidate list. Meanwhile, since the running unit 100A meets the required specifications of a transportation service and a charging service, these two services remain as candidates. In the time slot-based narrowing-down step (S604), since the period when the transportation service is provided is from 12:00 to 16:00, the available time slot of the running unit 100A expires before the running unit 100A returns to the parking lot PA. Hence, the transportation service is removed from the candidate list. Meanwhile, since the charging service has to be completed at least by 14:00, the entire service can be completed during the available time slot that is between 9:00 and 16:00 even considering the travel time between the service-provided position and the parking lot PA and the charging time. Therefore, the charging service remains a candidate. In the narrowing-down step based on the power consumption (S605), in the charging service, the sum of the amount of power required for movement and the amount of power required for charging is compared with the remaining battery level of the running unit 100A. Here, the running unit 100A has a sufficient remaining battery level, and the charging service therefore remains as a candidate. Since only the charging service remains as a candidate as described above, the charging service is selected as the service to be assigned to the running unit 100A (S606).

[S509 and S511: Command Generation and Command Transmission]

Upon completion of the matching process S505, whether there is a service to be combined with the running unit 100A is determined in Step S507. When a positive determination is made, the process proceeds to Step S509, and when a negative determination is made, the process proceeds to Step S513.

In Step S509, the command generation unit 2048 of the server device generates an operation command that indicates the control that the running unit 100A should execute in order to provide the selected service. The operation command includes a travel plan that indicates how the running unit 100A should run.

In Step S511, the information providing unit 2049 transmits the operation command to the running unit 100A as control information for autonomous driving of the running unit 100A (Step S511).

In Step S513, the vehicle information acquisition unit 2045 determines whether there is any running unit 100 (100B, . . . ) other than the running unit 100A. This determination is executed for the running unit 100 managed by the server device 200. This is performed for multiple running units 100 in a predetermined order, and when any running unit 100 is still left, this running unit 100 is designated and a negative determination is made in Step S513. As such, the steps following Step S501 described above are executed for the designated running unit 100.

When no running unit 100 is left, a positive determination is made in Step S513. Thus, the process ends.

### Advantageous Effects of Embodiment

According to this embodiment, with a vehicle including a running unit and an attachment unit, when the running unit can be used separately from the attachment unit, the running unit can be used for an appropriate service. The provision of various services in the running unit is promoted during a time slot when the running unit is available. Therefore, the range of application of the running unit can be extended.

<Modification>

The aforementioned embodiment is merely illustrative and appropriate modification can be made without departing from the scope of the present disclosure. The processing and/or means described in this disclosure can be partly implemented or freely combined unless technical inconsistencies arise.

An example in which only one service is assigned in the available time slot of the running unit has been explained above. However, multiple services may be assigned to the running unit. If the running unit and the service meet the matching condition, for example, in the available time slot from 9:00 to 16:00, the running unit may be determined to be used for the first service from 10:00 to 12:00, and for the second service from 13:00 to 15:00.

The matching process may be replaced by a process different from that in the flowcharts illustrated in FIGS. 5 and 6. In the flowchart of FIG. 5, a loop process is performed on the running units 100 to perform a matching process to determine services matching the running unit 100A, 100B, . . . . Alternatively, a loop process may be performed on the services to perform a matching process to determine running units matching services 1, 2, . . . .

Alternatively, the matching process may be performed using a known algorithm for solving a bipartite matching problem, such as a network flow algorithm or a dynamic programming method, instead of the simple loop illustrated in FIG. 5 in order to determine combinations between running units and services.

Processing supposed to be done with one device according to the above description may be executed with multiple devices. For instance, the server device 200, which is an information processing apparatus, and/or the information processing apparatus 102 of the running unit 100 each does not have to be one computer, and may be configured as a system including multiple computers. Alternatively, processing supposed to be done with different devices according to the above description may be executed with one device. In a computer system, the type of hardware configuration used to implement each function can be flexibly changed.

The present disclosure can be implemented when a computer program having the functions that have been described in the above embodiment is supplied to a computer, and one or more processors in the computer read and execute the program. Such a computer program may be provided to the computer via a non-transitory computer-readable memory medium that can be connected to the computer's system bus or via a network. Examples of non-transitory computer-readable memory medium include any type of disks such as magnetic disks (such as floppy (registered trademark) disks and hard disk drives (HDDs)), and optical disks (such as CD-ROMs, DVD disks, and Blu-ray disks), read only memories (ROMs), random access memories (RAMs), EPROMs, EEPROMs, magnetic cards, flash memories, optical cards, and any type of media suitable for storing electronic instructions.

What is claimed is:

1. An information processing apparatus comprising a control unit configured to
acquire, for a running unit from which an attachment unit is detachable, a time slot in which detachment of the attachment unit is permitted, and
select, from multiple services, a service to be provided by using the running unit from which the attachment unit is detached, according to the acquired time slot.

2. The information processing apparatus according to claim 1, wherein the selection involves selecting, by a process of matching between multiple running units and multiple services, at least one service from the multiple services, for at least one running unit of the multiple running units.

3. The information processing apparatus according to claim 1, wherein
the control unit
acquires specifications of the running unit, and
acquires specifications required for the running unit to use for each of the multiple services, and
the service is selected according to determination of whether the specifications of the acquired running unit satisfy the required specifications.

4. The information processing apparatus according to claim 1, wherein
the control unit
acquires positional information on the running unit in the time slot, and
acquires, for each of the multiple services, a service-provided position, and
the service is selected according to a result of comparison between the acquired positional information on the running unit and the service-provided position.

5. The information processing apparatus according to claim 1, wherein
the control unit also acquires permission information indicating a service permitted by the owner of the running unit to use the running unit, and
the service is selected according the acquired permission information.

6. The information processing apparatus according to claim 1, wherein
the control unit
also acquires a remaining battery level of the running unit, and
estimates, for each of the multiple services, the amount of power consumed by the running unit in service provision, and
the service is selected according to determination of whether the acquired remaining battery level is higher than the estimated amount of power.

7. The information processing apparatus according to claim 1, wherein
the control unit
also generates a travel plan for the running unit for the selected service, and
transmits the generated travel plan as control information for autonomous driving of the running unit.

8. The information processing apparatus according to claim 1, wherein
the acquisition of the time slot involves:
acquiring schedule information on a user of the attachment unit, and
estimating the time slot according to the schedule information.

9. The information processing apparatus according to claim 8, wherein
the acquisition of the time slot involves:
acquiring a remaining battery level of the running unit, and
estimating the time slot according to the remaining battery level.

10. The information processing apparatus according to claim 1, wherein
the multiple services include at least one of the group consisting of a patrol service, an object or human transporting service, a service for supplying power to a second running unit different from the running unit, and a service for transporting the second running unit.

11. An information processing method wherein
at least one computer
acquires, for a running unit from which an attachment unit is detachable, a time slot in which detachment of the attachment unit is permitted, and
selects, from multiple services, a service to be provided by using the running unit from which the attachment unit is detached, according to the acquired time slot.

12. The information processing method according to claim 11, wherein the selection involves selecting, by a process of matching between multiple running units and multiple services, at least one service from the multiple services, for at least one running unit of the multiple running units.

13. The information processing method according to claim 11, wherein
the at least one computer
acquires specifications of the running unit, and
acquires specifications required for the running unit to use for each of the multiple services, and
the service is selected according to determination of whether the specifications of the acquired running unit satisfy the required specifications.

14. The information processing method according to claim 11, wherein
the at least one computer
acquires positional information on the running unit in the time slot, and
acquires, for each of the multiple services, a service-provided position, and
the service is selected according to a result of comparison between the acquired positional information on the running unit and the service-provided position.

15. The information processing method according to claim 11, wherein
the at least one computer also acquires permission information indicating a service permitted by the owner of the running unit to use the running unit, and
the service is selected according the acquired permission information.

16. The information processing method according to claim 11, wherein
the at least one computer
also acquires a remaining battery level of the running unit, and
estimates, for each of the multiple services, the amount of power consumed by the running unit for service provision, and
the service is selected according to determination of whether the acquired remaining battery level is higher than the estimated amount of power.

17. The information processing method according to claim 11, wherein
the at least one computer
also generates a travel plan for the running unit for the selected service, and
transmits the generated travel plan as control information for autonomous driving of the running unit.

18. The information processing method according to claim 11, wherein
the acquisition of the time slot involves:
acquiring schedule information on a user of the attachment unit, and
estimating the time slot according to the schedule information.

19. The information processing method according to claim 11, wherein
the multiple services include at least one of the group consisting of a patrol service, an object or human transporting service, and a service for supplying power to a second running unit different from the running unit.

20. A non-transitory memory medium storing a program that causes at least one computer to
acquire, for a running unit from which an attachment unit is detachable, a time slot in which detachment of the attachment unit is permitted, and
select, from multiple services, a service to be provided by using the running unit from which the attachment unit is detached, according to the acquired time slot.
